(19) United States
(12) Patent Application Publication
(10) Pub. No.: US 2026/0086356 A1
(43) Pub. Date: Mar. 26, 2026

(54) Camera Calibration with Gaze Tracking

(71) Applicant: Apple Inc., Cupertino, CA (US)

(72) Inventors: Stergios Roumeliotis, Los Altos Hills, CA (US); Daniel C Byrnes, San Francisco, CA (US); Lionel E Edwin, San Jose, CA (US); Tom Sengelaub, Oakland, CA (US)

(73) Assignee: Apple Inc., Cupertino, CA (US)

(21) Appl. No.: 19/339,105

(22) Filed: Sep. 24, 2025

Related U.S. Application Data
(60) Provisional application No. 63/699,615, filed on Sep. 26, 2024.

(51) Int. Cl. G02B 27/00; G02B 27/01; H04N 13/246

(52) U.S. Cl. CPC G02B 27/0093; G02B 27/0172; H04N 13/246; G02B 2027/0138; G02B 2027/014; G02B 2027/0141

(57) ABSTRACT

Forward and backward facing cameras on a head mounted device may be calibrated to each other using gaze tracking while the eye is directed to an external target that is within view of the forward-facing camera. The use of gaze tracking as a calibration proxy enables camera calibration without equipment other than the head mounted device. Camera calibration enables the head mounted device to determine where in an external scene a user wearing the head mounted device is directing the user's gaze.

### PRIORITY CLAIM

This application claims benefit of priority to U.S. Provisional Application Ser. No. 63/699,615, entitled “Camera Calibration with Gaze Tracking”, filed Sep. 26, 2024, and which is incorporated herein by reference in its entirety.

### BACKGROUND

### Description of the Related Art

A pair of cameras which are uncalibrated may each produce information that is not in context with information produced by the other camera. Camera calibration may be performed by identifying a common point in an overlapping field of view between two cameras. For cameras without an overlapping field of view, specialized equipment such as particularly angled mirrors may be needed for identification of a common point.

### SUMMARY

A head mounted device may perform camera calibration for cameras set on a head mounted device which are directed away from each other by using, with proper user permissions, gaze tracking. A head mounted device may use a calibrated pair of cameras to associate movement of a user's eye with a gaze target in an external scene. The external scene may be within a field of view of a camera fixed to the exterior of the head mounted device, and the user's eye may be within a field of view of another camera fixed to the interior of the head mounted display. The head mounted display may have less accurate gaze target identification when using information from an uncalibrated camera pair than when using information from a calibrated camera pair. Cameras may become uncalibrated due to deformation of the head mounted display, for example, the head mounted display may become bent, twisted, or otherwise deformed in such a way that the camera pair has a new rotational configuration relative to each other.

Cameras which are attached to the same object, such as a frame of a head mounted device, in different directions may not have overlapping fields of view while the device is powered on, for example, while a user is wearing the head mounted device. For example, a camera mounted on the exterior of a head mounted device may not have a view of the user's eye while the head mounted device is worn by the user. Similarly, a camera mounted to the interior of the head mounted device may not have a view of an external scene while the head mounted device is being worn by the user.

A calibration system of the head mounted device may use gaze tracking techniques at a time the user is likely to be gazing at a particular target which may be in the field of view of the external camera to determine a gaze vector with an association to a camera vector from the external camera to the gaze target. The calibration system may be able to determine calibration information based on the gaze vector and the camera vector. For example, the calibration system may determine changes in relative rotation between the internal camera to the external camera. Also, in some embodiments, relative position changes due to translation of one of the cameras relative to the other may be determined. For example, a gaze tracking system using calibration information from the calibration system may be able to determine what target, in the field of view of the external camera, the user is gazing at based on a new gaze vector.

### BRIEF DESCRIPTION OF THE DRAWINGS

FIG. 1 is a top view of a head mounted display with a world camera and a gaze camera, with a respective camera vector and gaze vector, according to some embodiments.

FIG. 2A is a block diagram of a camera vector in relation to a gaze target, according to some embodiments.

FIG. 2B is a block diagram of a measured gaze vector in relation to a gaze target, according to some embodiments.

FIG. 2C is a block diagram of the camera vector in relation to the measured gaze vector, according to some embodiments.

FIG. 3A is a block diagram of a camera vector and measured gaze vector at a first time, such as when the gaze target is in a particular position relative to the head mounted device, according to some embodiments.

FIG. 3B is a block diagram of another camera vector and another measured gaze vector at a second time, such as when the gaze target is in another particular position relative to the head mounted device, according to some embodiments.

FIG. 3C is a block diagram illustrating the components a calibration system may use for determining a calibration matrix, according to some embodiments.

FIG. 4 is a block diagram illustrating the components a calibration system may use for determining the user's gaze is directed to a particular target based on calibration information, according to some embodiments.

FIG. 5A is a front view of an external scene which includes a companion device which indicates a gaze target for the user, according to some embodiments.

FIG. 5B is a front view of an external scene which includes a companion device which has an inferred gaze target based on an action of the user, according to some embodiments.

FIG. 5C is a front view of an external scene which includes a display from the head mounted device which has an inferred gaze target based on an action of the user, according to some embodiments.

FIG. 6 is a flowchart illustrating a method of determining and using calibration information for cameras of a head mounted device, according to some embodiments.

FIG. 7A is a side view of a headset-type head-mounted device, according to some embodiments.

FIG. 7B is a front view of a headset-type head-mounted device, according to some embodiments.

FIG. 7C a back view of a headset-type head-mounted device, according to some embodiments.

FIG. 7D a front view of a glasses-type head-mounted device, according to some embodiments.

FIG. 7E a back view of a glasses-type head-mounted device, according to some embodiments.

FIG. 8 is a block diagram illustrating an example computing device that may be used, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, paragraph (f), for that unit/circuit/component. Additionally, “configured to” can include generic structure (e.g., generic circuitry) that is manipulated by software or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

### DETAILED DESCRIPTION

A calibration system for a head mounted device may use, with appropriate user permissions, gaze tracking to calibrate a pair of cameras mounted to the head mounted device. One camera may be an external, or world, camera which is attached to the head mounted device so as to be directed away from a user while the user is wearing the head mounted device. The other camera of the pair may be an interior, or gaze, camera which is attached to the head mounted device so as to be directed towards an eye of the user while the user is wearing the head mounted device. The calibration system may provide calibration information to a target selection system, which may enable the target selection system to select a target the user is gazing at based on gaze tracking information and information from an external camera.

When a user is wearing the head mounted device, the gaze camera and the world camera may have fields of view which do not overlap and do not include a possible shared target. The gaze camera may have a field of view which may include the eye and face of a user and not any of an external scene, and the world camera may have a field of view which includes an external scene and not any of the eye or face of the user. When the head mounted device is manufactured, a rotational configuration of the gaze camera and world camera may be known to the head mounted device and gaze target identification may be accurate. Damage to the head mounted device, such as deformation to a portion of the head mounted device between the external camera and the gaze camera, may change the rotational configuration of the cameras respective to each other and reduce the accuracy of gaze target identification. The cameras may be calibrated to each other to account for the deformation of the head mounted device to improve the accuracy of gaze target identification.

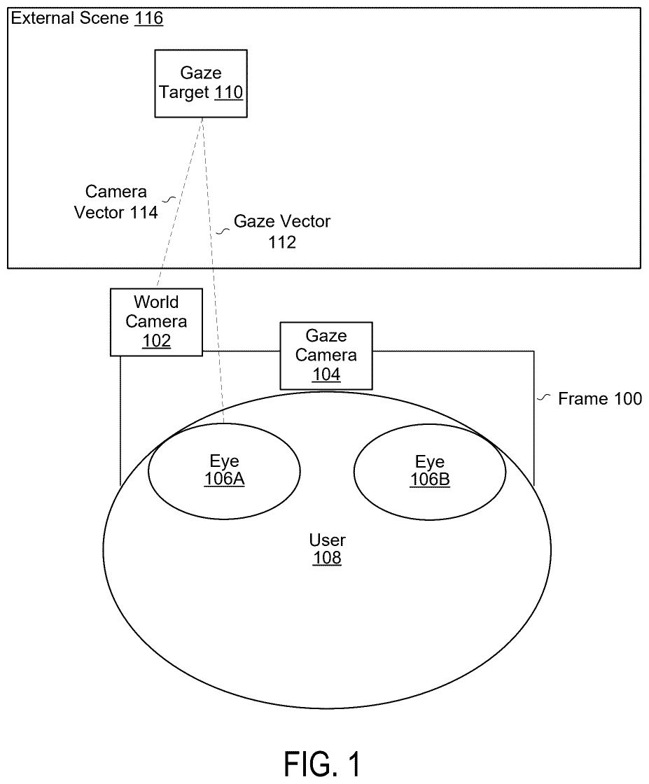

FIG. 1 is a top view of a head mounted display with a world camera and a gaze camera, with a respective camera vector and gaze vector, according to some embodiments.

A user 108 may wear a head mounted device to view an external scene 116. The external scene 116 may include a gaze target 110, which the user 108 may observe with the center of vision of an eye 106. The gaze target 110 may be in the field of view of a world camera 102. The eye 106 of the user 108 may be in the field of view of a gaze camera 104. While gaze tracking and camera calibration may be performed using both eye 106A and eye 106B, the process is the same for both.

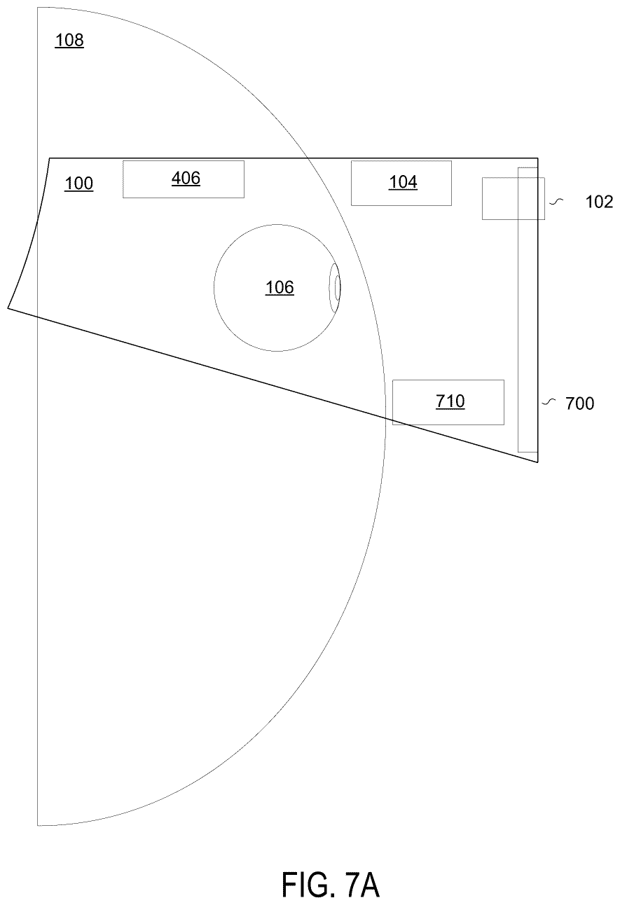

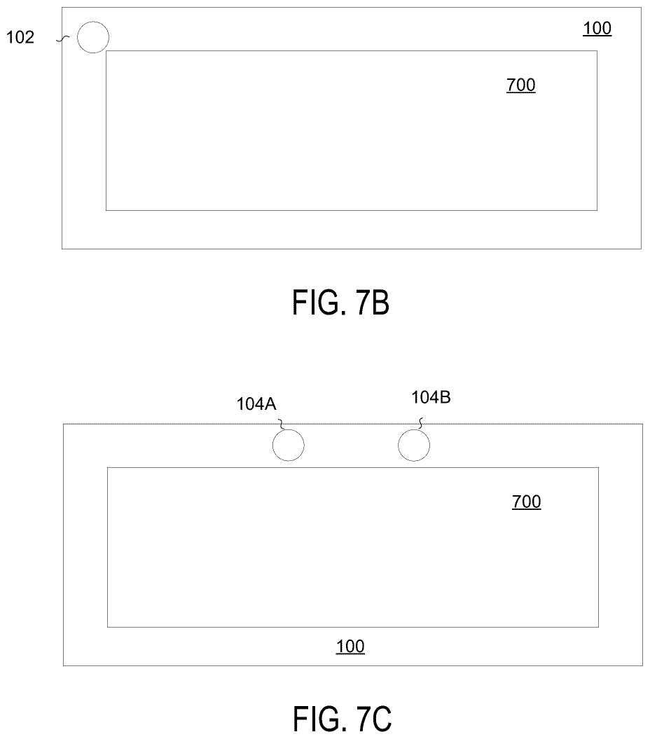

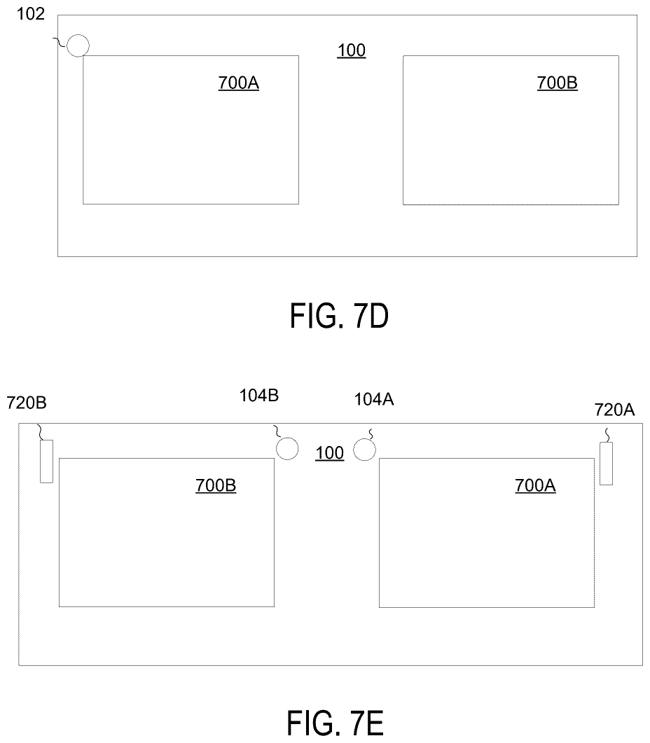

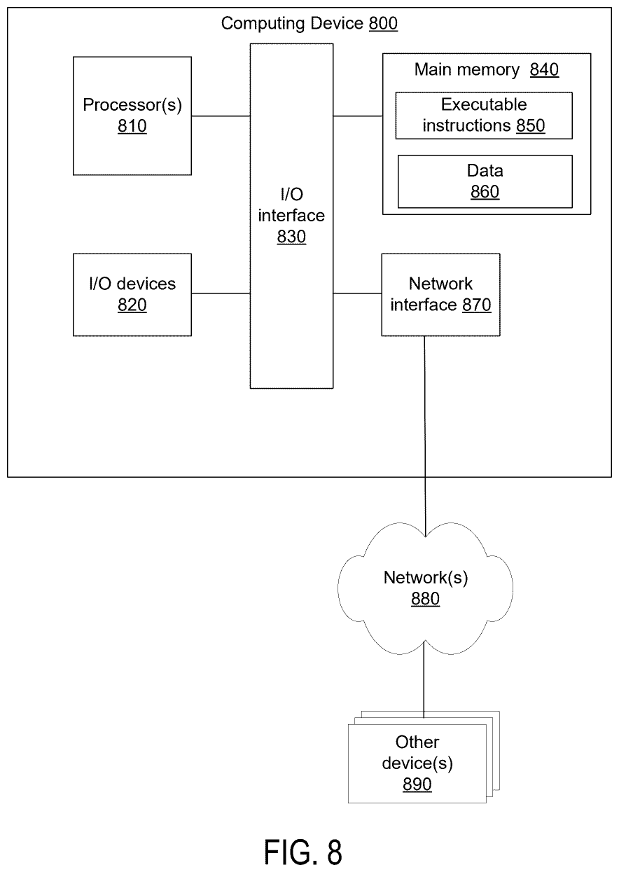

The world camera 102 and gaze camera 104 may be attached to a frame 100 of the head mounted device. The world camera 102 may be a visible light camera in some embodiments, and may be an invisible light (such as infrared, near-infrared, and ultraviolet light) camera in some embodiments. The gaze camera 104 may similarly be a visible or invisible light camera in some embodiments. The gaze camera 104 may be another sensor suitable for gaze tracking in some embodiments, for example, a frequency modulated continuous wave lidar sensor. The frame 100 of the head mounted device may be a frame 100 as illustrated in FIGS. 7A-7E. The head mounted device may comprise or communicate with a controller, such as a computing device 800 as illustrated in FIG. 8.

The controller may use one or more images or information (i.e., gaze information) provided by the gaze camera 104 to determine a direction the eye 106 is directed. The controller may represent the gaze direction as a gaze vector 112. The controller may determine, based on an indication provided to the user 108 or an inference based on an action of the user 108, a gaze target 110. The controller may determine a direction from the world camera 102 to the gaze target 110, which the controller may represent as a camera vector 114. The controller may be implementing a calibration system, which may use the gaze vector 112 and camera vector 114 to determine calibration information between the gaze camera 104 and the world camera 102. The controller may implement the calibration system in response to a determination that the world camera 102 and gaze camera 104 are to be calibrated, for example, when there is an indication that a deformation of the frame 100 has occurred or on request of the user 108 due to an inaccuracy in gaze target determination.

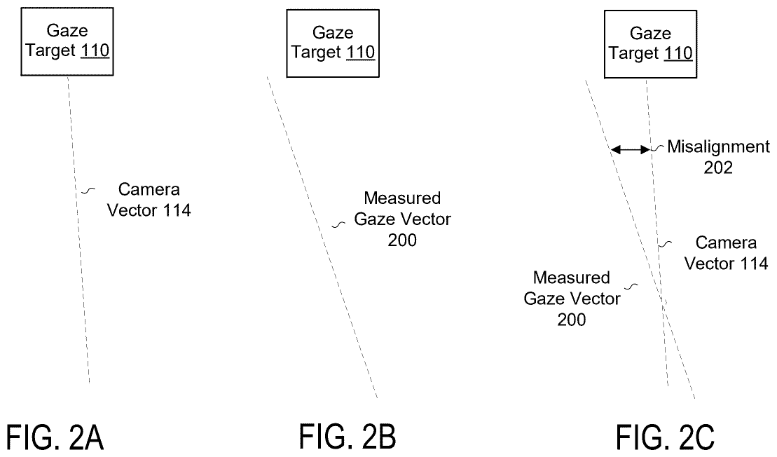

FIG. 2A is a block diagram of a camera vector in relation to a gaze target, according to some embodiments.

The camera vector 114 may be a representation of the direction of a gaze target 110 in relation to an external camera, such as a world camera. The camera vector 114 may have the camera as an origin. In some embodiments, the calibration system may use the position of the gaze target 110 in an image captured by the external camera to determine the camera vector 114. For example, the vertical axis of the image may correspond to a dimension of the camera vector 114 and the horizontal axis of the image may correspond to a dimension of the camera vector 114. An example camera vector 114 may be represented by u=<x, y> where x represents the horizontal direction from the world camera to the gaze target 110 and y represents the vertical direction from the world camera to the gaze target 110. In some embodiments, the calibration system may determine a distance from the world camera to the gaze target 110, which may be represented as a dimension in the camera vector 114.

FIG. 2B is a block diagram of a measured gaze vector in relation to a gaze target, according to some embodiments.

The calibration system may assume that the user is gazing at the gaze target 110. The measured gaze vector 200 may represent a gaze direction of the user's eye, as determined based on the information included in images captured by the gaze camera. The measured gaze vector 200 may have the eye as an origin. The measured gaze vector 200 may not correspond to the direction from the eye to the gaze target 100 as a result of a deformation of the frame of the head mounted display which affects the rotational configuration of the world camera and the gaze camera. The gaze tracking system which the calibration system uses to generate the measured gaze vector 200 may provide a direction the eye is gazing, which may not be aligned with information about the external scene taken from images the world camera captured. An example gaze vector may be represented by v=<a, b> where a represents the horizontal direction that the eye is apparently gazing, (i.e., azimuth, corresponding to yaw rotation of the eye) and b represents the vertical direction the eye is apparently gazing, (i.e., elevation, corresponding to pitch rotation of the eye). The calibration system may use the information provided by the world camera to determine information about the gaze target 110, so a measured gaze vector 200, determined using a gaze camera that is not calibrated to the world camera, may not intersect with the gaze target 110.

FIG. 2C is a block diagram of the camera vector in relation to the measured gaze vector, according to some embodiments.

The misalignment 202 between the camera vector 114 and the measured gaze vector 200 may be calibration information that the calibration system may determine. The user may actually be gazing at the gaze target 110, and the misalignment 202 may indicate that deformation of the frame has occurred between with world camera, which provided the one or more images used to identify the gaze target 110 and generate the camera vector 114, and the gaze camera, which provided one or more images used in gaze tracking to generate the measured gaze vector 200. The calibration system may generate calibration information which a gaze target determiner may use to account for the misalignment 202 in gaze target determinations.

For a calibrated pair of world camera and gaze camera, there may be no misalignment 202. The distance between the origins for the camera vector 114 (world camera) and gaze vector (eye) may be negligible for a gaze target 110 at a distance beyond a threshold, such as 1 meter or more. For distances beyond the threshold, the aligned camera vector 114 and measured gaze vector 200 may be the same vector. The camera vector 114 and the measured gaze vector may intersect at the gaze target 110 for distances below the threshold limit where the distance between the world camera and eye is not negligible.

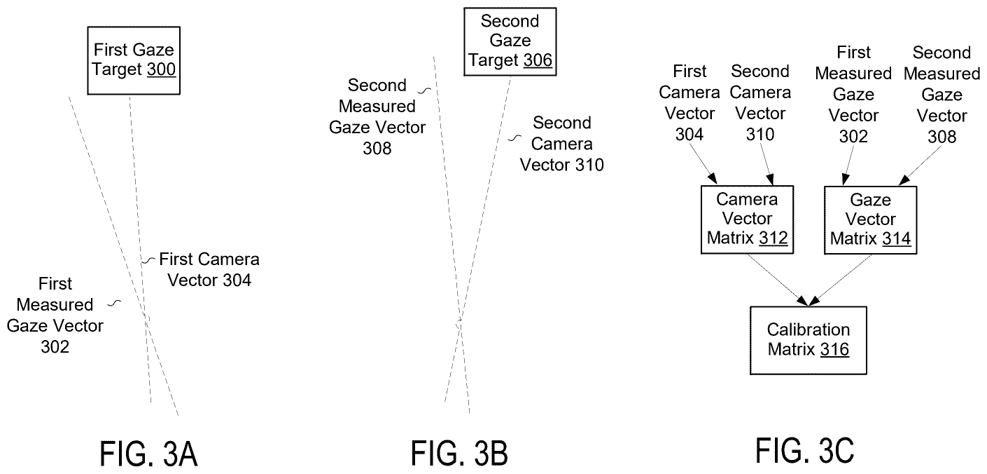

FIG. 3A is a block diagram of a camera vector and measured gaze vector at a first time, such as when the gaze target is in a particular position relative to the head mounted device, according to some embodiments.

The calibration system may use multiple pairs of camera vectors and gaze vectors to determine calibration information. The gaze targets may vary between pairs of camera vectors and gaze vectors. The first gaze target 300 and the second gaze target 306 may be located at different positions in the external scene in the field of view of the world camera.

An example first camera vector 304 may be represented by u₁=<x₁, y₁>. An example first measured gaze vector 302 may be represented by v₁=<a₁, b₁>. The calibration system may use a label other than a subscript to associate the first camera vector 304 and the first measured gaze vector 302. The first camera vector 304 and the first measured gaze vector 302 may be associated with each other because they are based on information obtained from images taken in temporal proximity to each other (e.g., images taken within a threshold time limit of each other, such as 0.01 or 0.1 seconds). In some embodiments, the associated vectors may be based on information obtained from images taken with an intended time delay to account for the time of an eye moving to a particular gaze position once the first gaze target 300 is indicated to the user. In some embodiments the time delay may be determined based on a residual error of the generated calibration information. For example, u and v may be a set of camera and gaze vectors with a known time relationship (i.e., u is 0.5 seconds before v) and C may be calibration information generated using the set of camera and gaze vectors with a known time relationship. The residual error may be represented, for example, by r=∥u−C·v|. The calibration system may determine the time delay by generating C and r for various sets of camera and gaze vectors with a known time relationship. For example, one set of camera and gaze vectors may be camera vectors with a 0.1 second time difference from corresponding gaze vectors, and another set of camera and gaze vectors may be camera vectors with a 0.2 second time difference from corresponding gaze vectors. The calibration system may select C generated by the set of camera and gaze vectors with a known time delay that corresponds to the lowest r as the calibration information. The gaze camera and the world camera may, in some embodiments, simultaneously capture images for generating, respectively, gaze information and world information.

FIG. 3B is a block diagram of another camera vector and another measured gaze vector at a second time, such as when the gaze target is in another particular position relative to the head mounted device, according to some embodiments.

The second gaze target 306 may be in a different position in the external scene than the first gaze target 300. The second camera vector 310 may be different from the first camera vector 304, and the second measured gaze vector 308 may be different from the first measured gaze vector 302. An example second camera vector 310 may be represented by u₂=<x₂, y₂>. An example second measured gaze vector 308 may be represented by v₂=<a₂, b₂>. The second camera vector 310 and second measured gaze vector 308 may be associated based on the temporal proximity of the capture of the images which supplied the world information and gaze information for generating the second camera vector 310 and second measured gaze vector 308.

FIG. 3C is a block diagram illustrating the components a calibration system may use for determining a calibration matrix, according to some embodiments.

The calibration system may combine the first camera vector 304 and the second camera vector 310 into a camera vector matrix 312. For example, the camera vector matrix 312 may be represented by U=[u₁, u₂]. The calibration system may combine the first measured gaze vector 302 and the second measured gaze vector 308 into a gaze vector matrix 314. For example, the gaze vector matrix 314 may be represented by V=[v₁, v₂]. In some embodiments, the camera vector matrix 312 and gaze vector matrix 314 may include the cross products of the first and second vectors, which may enable the calibration system to determine calibration information for deformation of the head mounted device corresponding to roll rotation. For example, the camera vector matrix 312 may be represented by U=[u₁, u₂, u₁×u₂] and the gaze matrix 314 may be represented by V=[v₁, v₂, v₁×v₂].

The calibration system may generate calibration information by determining rotational misalignment between the world camera and the gaze camera. For example, the calibration system may generate a calibration matrix 316. The calibration matrix 316 may be represented by C and may be determined by the example formula where V^{T} is the column matrix of V:

$$C = {{UV}^{T} ( {VV}^{T} )}^{- 1}$$

A calibration system using the above example formula may assume that the distance between the world camera and the eye is negligible. Another approach may be to use the distances between the world camera, the gaze camera, and the gaze targets to determine the calibration information. A calibration system using a companion device may be aware of distances between gaze targets on the companion device based on the locations the gaze targets appear on the device and the size of the displayable area of the device. The calibration system may also be aware of the distance and rotational situation from a particular point of the companion device relative to the world camera and gaze camera based on communication between the companion device and the head mounted device. The calibration system may determine a distance from the particular gaze targets to the world camera and eye based on the locations of the gaze targets on the companion device and the distance and rotational situation from the particular point of the companion device relative to the world camera and gaze camera.

For a calibration system which accounts for distance between the cameras, a camera vector for a first gaze target may be determined by the example formula

$${u}_{1} = \frac{{p}_{1} - {p}_{c}}{{d}_{1}} .$$

p₁ may represent the vector from the world camera to the first gaze target, which may be the vector which is used as a camera vector for a calibration system that does not account for distance between the cameras. p_{c} may represent the vector from the world camera to the gaze camera. d₁ may represent the distance between the first gaze target and the gaze camera. For example, d₁=∥p₁−p_{c}∥. Similarly, a camera vector for the second gaze target could be represented

$${u}_{2} = \frac{{p}_{2} - {p}_{c}}{{d}_{2}} ,$$

where p₂ represents the vector from the world camera to the second gaze target and d₂ represents the distance between the second gaze target and the gaze camera (i.e., d₂=∥p₂−p_{c}∥).

The calibration system may use gaze tracking to determine the gaze vectors. The camera vectors are normalized by distance from the gaze targets to the gaze camera. Accordingly, the gaze vectors may also be normalized, such that a gaze direction may be used as a gaze vector directly. Gaze tracking techniques may be used to determine a gaze direction based on one or more images of an eye captured by a gaze camera.

The calibration system may combine the calculated camera and gaze vectors in a camera matrix 312 and a gaze matrix 314 as was done in the previous example, for example, the camera matrix 312 may be represented by U=[u₁, u₂, u₁×u₂] and the gaze matrix 314 may be represented as V=[v₁, v₂, v₁×v₂]. The Cross-Product of the Calculated Vectors May Account for deformation of the head mounted display device that resulted in roll rotation of the world camera and gaze camera relative to each other. U may represent the camera matrix 312 and V may represent the gaze matrix 314. The calibration matrix 316 may be represented by C and may be determined by the example formula, where V^{T} is the column matrix of V:

$$C = Proj ( {{UV}^{T} ( {VV}^{T} )}^{- 1}$$

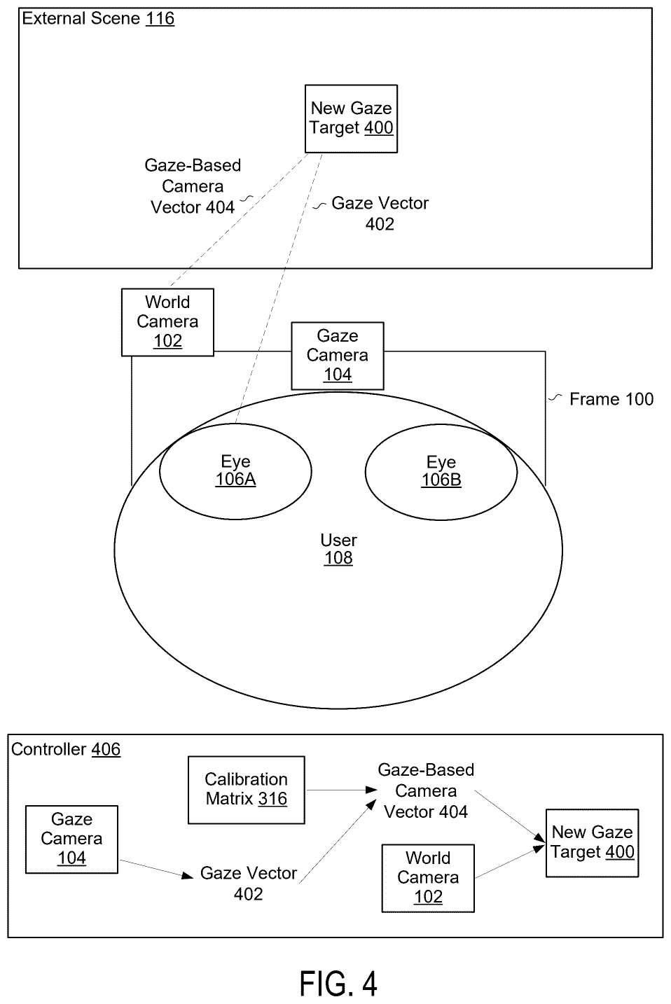

FIG. 4 is a block diagram illustrating the components a calibration system may use for determining the user's gaze is directed to a particular target based on calibration information, according to some embodiments.

A gaze target determiner may use the calibration information to determine that the user 108 is gazing at a new gaze target 400. The gaze target determiner may not know the specific target prior to combining the calibration information with a gaze vector 402 directed to the new gaze target 400 to obtain gaze-based camera vector 404. A controller 406, which may be similar to computing device 800 as illustrated in FIG. 8, may be implementing a gaze target determiner.

The gaze target determiner may obtain information from a gaze camera 104. The gaze camera 104 may be directed towards an eye 106 of a user 108 and may capture images which the controller may use to determine gaze information, such as a direction the user is gazing. The controller 406 may use a gaze tracking system to determine the gaze direction based on one or more images captured from the gaze camera 104. The gaze direction towards the new gaze target 400 may be associated with a gaze vector 402.

The gaze target determiner may use calibration information, such as calibration matrix 316, in combination with the gaze vector 402 to generate gaze-based camera vector 404. The gaze target determiner may account for a deformation of the frame 100 of the head mounted device between the world camera 102 and the gaze camera 104 using the calibration information, for example using the formula u=C·v, where C represents the calibration matrix 316 which the calibration system may have determined as described in relation to FIG. 3C, v represents the gaze vector 402, and u represents the gaze-based camera vector 404. The gaze target determiner may compare the gaze-based camera vector 404 to information obtained from images taken by a world camera 102 to determine a new gaze target 400. The information obtained from images taken by a world camera 102 may include the positions of potential gaze targets in the external scene 116.

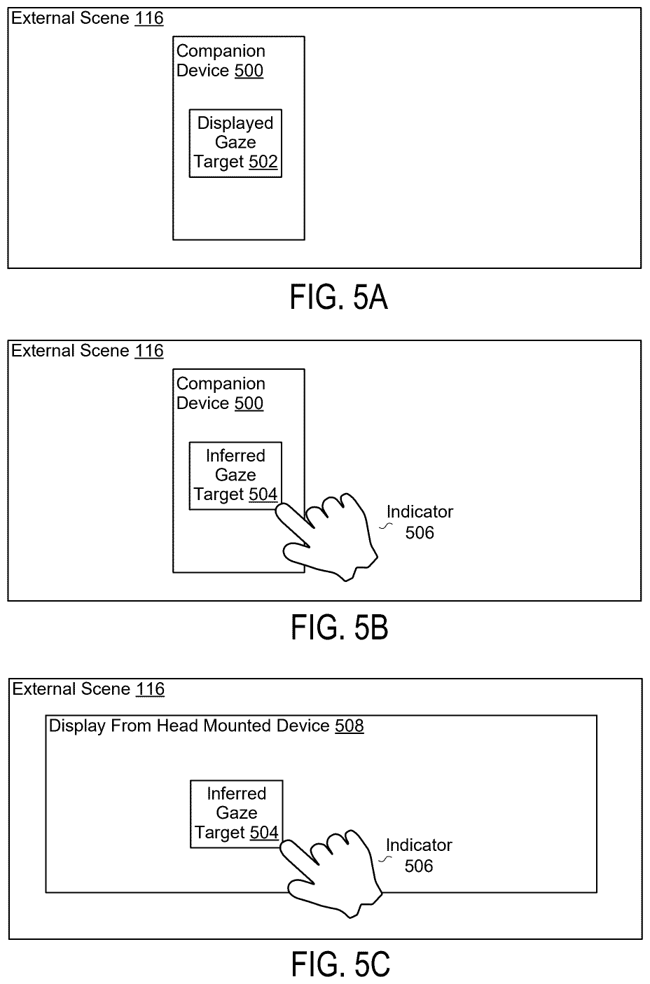

FIG. 5A is a front view of an external scene which includes a companion device which indicates a gaze target for the user, according to some embodiments.

FIGS. 5A-5C illustrate examples of external targets a calibration system may use. A calibration system may use other types of external targets. For example, the calibration system may audibly indicate the user should gaze at a particular point of an external scene, or the calibration system may select an external target the user has been instructed to look at by someone or something other than the calibration system.

An external scene 116, which may be the field of view of an external camera, may include a companion device 500, such as a smartphone, tablet, smart watch, or other personal device. The companion device 500 may connect to the head mounted display and may display a displayed gaze target 502. The head mounted device or the companion device 502 may instruct the user to gaze at the displayed gaze target 502. The calibration system may use the displayed gaze target 502 as an external target on which to base a camera vector which is to be associated with a gaze vector.

FIG. 5B is a front view of an external scene which includes a companion device which has an inferred gaze target based on an action of the user, according to some embodiments.

The external scene 116 may include a companion device 500, such as a smartphone, tablet, smart watch, or other personal device. The user may interact with the companion device 500 using an indicator 506, such as a finger or a stylus. The user may interact with a touchscreen of the companion device 500 by touching a particular location of the touchscreen. The calibration system may infer that the user is gazing at the location the user is touching with an indicator 506 and may determine the point is an inferred gaze target. The calibration system may use the inferred gaze target as an external target on which to base a camera vector that is to be associated with a gaze vector.

FIG. 5C is a front view of an external scene which includes a display from the head mounted device which has an inferred gaze target based on an action of the user, according to some embodiments.

The external scene 116 may include a display from the head mounted device 508, such as a projection on a transparent surface in front of the user's eyes which causes the display to appear to exist in the external scene 116. The projector may be aligned with the external camera, and the location of points of the display relative to the external scene 116 may be known to a controller of the head mounted device. The user may use an indicator 506, such as a hand or a finger or of the user, to interact with a portion of the display from the head mounted device 508. The indicator 506 may be within the field of view of the external camera. The calibration system may infer that the user is gazing at the point the user is indicating with the indicator 506 and may determine that point is an inferred gaze target 504 which may be used as an external target.

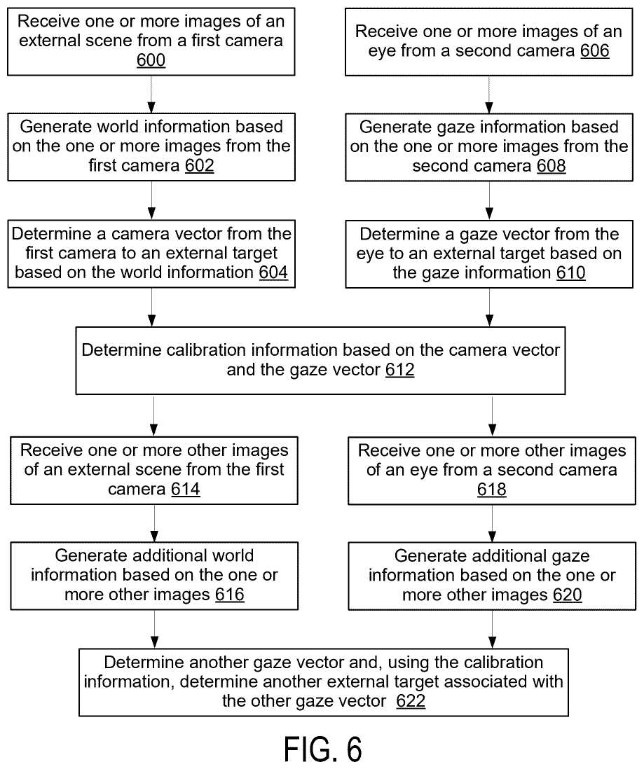

FIG. 6 is a flowchart illustrating a method of determining and using calibration information for cameras of a head mounted device, according to some embodiments.

At 600, a calibration system of a head mounted device may receive one or more images of an external scene from a first camera, such as a world camera. At 602, the calibration system may generate world information, such as the position of an external target, based on the one or more images from the first camera. At 604, the calibration system may determine a camera vector from the first camera to the external target based on the world information.

At 606, the calibration system may receive one or more images of an eye from a second camera, such as a gaze camera. At 608, the calibration system may generate gaze information, such as a gaze direction through gaze tracking techniques, based on the one or more images from the second camera. At 610, the calibration system may determine a gaze vector from the eye to an external target based on the gaze information.

At 612, the calibration system may determine calibration information based on the camera vector and the gaze vector. The calibration information may include a calibration matrix, which may be based on a set of associated camera and gaze vectors. The calibration system may associate camera and gaze vectors with each other based on the images that resulted in the camera and gaze vectors being captured within a threshold period of time from each other. For example, the images referred to in step 600 may have been taken simultaneously to or within a threshold period of time as the images referred to in step 606 for the resulting camera vector and gaze vector to be associated.

At 614, a gaze target determiner of the head mounted device may receive one or more other images of an external scene from the first camera. At 616, the gaze target determiner may generate additional world information based on the one or more other images, such as the positions of potential gaze targets. At 618, the gaze target determiner may receive one or more other images of an eye from a second camera. At 620, the gaze target determiner may generate additional gaze information, such as another gaze vector, based on the one or more other images.

At 622, the gaze target determiner may determine another gaze vector based on the gaze direction and use the calibration information in combination with the other gaze vector to determine another external target associated with the other gaze vector.

FIG. 7A is a side view of a headset-type head-mounted device, according to some embodiments.

FIG. 7A illustrates an example head-mounted device (HMD) that may include components and implement methods as illustrated in FIGS. 1 through 6, according to some embodiments. As shown in FIG. 7A, the HMD may be positioned on the user's head 108 such that the display is disposed in front of the user's eyes 106. The user looks through the eyepieces (i.e., transparent surface 700, which may be one or more lenses) onto the display. The display may be projected onto the transparent surface 700 by a projector 710 of the head mounted device.

The HMD may include transparent surface 700, mounted in a wearable housing or frame 100. The HMD may be worn on a user's (the “wearer”) head so that the transparent surface 700 is disposed in front of the wearer's eyes 106. In some embodiments, an HMD may implement any of various types of display technologies or display systems. For example, the HMD may include a display system that directs light that forms images (virtual content) through one or more layers of waveguides in the transparent surface 700; output couplers of the waveguides (e.g., relief gratings or volume holography) may output the light towards the wearer to form images at or near the wearer's eyes 106. Projector 710 may output the light towards the transparent surface 700.

As another example, the HMD may include a direct retinal projector system (i.e., projector 710) that directs light towards reflective components of the transparent surface 700; a reflective lens(es) of the transparent surface 700 is configured to redirect the light to form images at the wearer's eyes 106. In some embodiments the display system may change what is displayed to at least partially affect the conditions and features of the eye 106. For example, the display may increase the brightness to change the conditions of the eye 106 such as lighting that is affecting the eye 106. Another example, the display may change the distance an object appears on the display to affect the conditions of the eye 106 such as the accommodation distance of the eye 106.

In some embodiments, HMD may also include one or more sensors that collect information about the wearer's environment (video, depth information, lighting information, etc.) and about the wearer (e.g., eye or gaze sensors). The sensors may include one or more of, but are not limited to one or more gaze cameras 104 (e.g., infrared (IR) cameras) that capture views of the user's eyes 106, one or more world-facing or PoV cameras 102 (e.g., RGB video cameras) that can capture images or video of the real-world environment in a field of view in front of the user, and one or more ambient light sensors that capture lighting information for the environment. World cameras 102 and gaze cameras 104 may be integrated in or attached to the frame 100. The HMD may also include one or more illumination sources such as LED or infrared point light sources that emit light (e.g., light in the IR portion of the spectrum) towards the user's eye or eyes 106.

A controller 406 for an authentication system may be implemented in the HMD, or alternatively may be implemented at least in part by an external device (e.g., a computing system or handheld device) that is communicatively coupled to the HMD via a wired or wireless interface. Controller 406 may include one or more of various types of processors, image signal processors (ISPs), graphics processing units (GPUs), coder/decoders (codecs), system on a chip (SOC), CPUs, and/or other components for processing and rendering video and/or images.

Memory for an authentication system may be implemented in the HMD in association with a controller 406, or alternatively may be implemented at least in part by an external device (e.g., a computing system) that is communicatively coupled to the HMD via a wired or wireless interface. The memory may, for example, be used to record video or images captured by the one or more cameras 102 and 104 integrated in or attached to frame 100. Memory may include any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., or low power versions of the SDRAMs such as LPDDR2, etc.), RAMBUS DRAM (RDRAM), static RAM (SRAM), etc.

In some embodiments, one or more memory devices may be coupled onto a circuit board to form memory modules such as single inline memory modules (SIMMs), dual inline memory modules (DIMMs), etc. Alternatively, the devices may be mounted with an integrated circuit implementing system in a chip-on-chip configuration, a package-on-package configuration, or a multi-chip module configuration. In some embodiments DRAM may be used as temporary storage of images or video for processing, but other storage options may be used in an HMD to store processed data, such as Flash or other “hard drive” technologies. This other storage may be separate from the externally coupled storage mentioned below.

While FIG. 7A only shows a gaze camera 104 for one eye 106, embodiments may include gaze cameras 104 for each eye 106, and camera calibration may be performed for both eyes 106. In addition, the gaze cameras 104 may be located elsewhere than shown. An HMD can have an opaque display, a transparent display, or a see-through display which allows the user to see the real environment through the display, while displaying virtual content overlaid on the real environment.

FIG. 7B is a front view of a headset-type head-mounted device, according to some embodiments.

A headset-type head-mounted device may include a transparent surface 700 set into a frame 100. The front of a headset-type head-mounted device may include a world-facing camera 102, which the device may use for various applications which rely on the device having access to the view a user may see through the transparent surface 700 of the device.

FIG. 7C a back view of a headset-type head-mounted device, according to some embodiments.

The back of a headset-type head-mounted device may be how the device appears to the user while the user is wearing the headset-type head-mounted device. The headset-type head-mounted device may include gaze camera 104A, which may be directed to the user's right eye, and gaze camera 104B, which may be directed to the user's left eye. The gaze cameras 104 may be set into the frame 100 of the headset-type head-mounted device. The user may view the environment through transparent surface 700 or may view images displayed on transparent surface 700. A head mounted device may include a projector to display images on transparent surface 700.

FIG. 7D a front view of a glasses-type head-mounted device, according to some embodiments.

A glasses-type head-mounted device may include transparent surface 700A and transparent surface 700B set into a frame 100. The front of a glasses-type head-mounted device may include a world camera 102, which the device may use for various applications which rely on the device having access to the view a user may see through the transparent surface 700 of the device.

FIG. 7E a back view of a glasses-type head-mounted device, according to some embodiments.

The back of a glasses-type head-mounted device may be how the device appears to the user while the user is wearing the glasses-type head-mounted device. The glasses-type head-mounted device may include gaze camera 104A, which may be directed to the user's right eye, and gaze camera 104B, which may be directed to the user's left eye. The gaze cameras 104 may be set into the frame 100 of the glasses-type head-mounted device. The user may view the environment through transparent surface 700 or may view images displayed on transparent surface 700. The glasses-type display device may include arms 720 attached to the frame 100 to keep the glasses-type display device in place.

FIG. 8 is a block diagram illustrating an example computing device that may be used, according to some embodiments.

In at least some embodiments, a computing device that implements a portion or all of one or more of the techniques described herein may include a general-purpose computer system that includes or is configured to access one or more computer-accessible media. FIG. 8 illustrates such a general-purpose computing device 800. In the illustrated embodiment, computing device 800 includes one or more processors 810 coupled to a main memory 840 (which may comprise both non-volatile and volatile memory modules and may also be referred to as system memory) via an input/output (I/O) interface 830. Computing device 800 further includes a network interface 870 coupled to I/O interface 830, as well as additional I/O devices 820 which may include sensors of various types.

In various embodiments, computing device 800 may be a uniprocessor system including one processor 810, or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA. In some implementations, graphics processing units (GPUs) may be used instead of, or in addition to, conventional processors.

Memory 840 may be configured to store instructions and data accessible by processor(s) 810. In at least some embodiments, the memory 840 may comprise both volatile and non-volatile portions; in other embodiments, only volatile memory may be used. In various embodiments, the volatile portion of system memory 840 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, executable program instructions 850 and data 860 implementing one or more desired functions, such as those methods, techniques, and data described above, are shown stored within main memory 840.

In one embodiment, I/O interface 830 may be configured to coordinate I/O traffic between processor 810, main memory 840, and various peripheral devices, including network interface 870 or other peripheral interfaces such as various types of persistent and/or volatile storage devices, sensor devices, etc. In some embodiments, I/O interface 830 may perform any necessary protocol, timing, or other data transformations to convert data signals from one component (e.g., main memory 840) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to memory 840, may be incorporated directly into processor 810.

Network interface 870 may be configured to allow data to be exchanged between computing device 800 and other devices 890 attached to a network or networks 880, such as other computer systems or devices. In various embodiments, network interface 870 may support communication via any suitable wired or wireless general data networks, such as types of Ethernet network, for example. Additionally, network interface 870 may support communication via telecommunications/telephony networks such as analog voice networks or digital fiber communications networks, via storage area networks such as Fibre Channel SANs, or via any other suitable type of network and/or protocol.

In some embodiments, main memory 840 may be one embodiment of a computer-accessible medium configured to store program instructions and data as described above for FIG. 1 through FIG. 7E for implementing embodiments of the corresponding methods and apparatus. However, in other embodiments, program instructions and/or data may be received, sent, or stored upon different types of computer-accessible media. Generally speaking, a computer-accessible medium may include non-transitory storage media or memory media such as magnetic or optical media, e.g., disk or DVD/CD coupled to computing device 800 via I/O interface 830. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 800 as main memory 840 or another type of memory. Further, a computer-accessible medium may include transmission media or signals such as electrical, electromagnetic, or digital signals, conveyed via a communication medium such as a network and/or a wireless link, such as may be implemented via network interface 870. Portions or all of multiple computing devices such as that illustrated in FIG. 8 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A head-mounted device, comprising:
a frame;
a first camera coupled to the frame and directed towards an external scene;
a second camera coupled to the frame and directed towards an eye of a user; and
one or more computing devices configured to:
generate world information based on one or more images of the external scene from the first camera, wherein the world information comprises a position of an external target in the external scene;
determine, based on the world information, a camera vector which corresponds to a direction from the first camera to the external target;
generate gaze information based on one or more other images of the eye from the second camera, wherein the gaze information comprises a gaze direction of the eye, wherein the gaze direction is associated with the external target;
determine, based on the gaze information, a gaze vector which corresponds to the gaze direction; and
determine, using the gaze vector and the camera vector, calibration information for calibrating the first camera and the second camera to each other.

2. The head-mounted device of claim 1, further comprising:
one or more transparent surfaces; and
one or more projectors directed toward the one or more transparent surfaces.

3. The head-mounted device of claim 1, wherein the calibration information is associated with a deformation of the frame.

4. The head-mounted device of claim 1, wherein the one or more computing devices are further configured to determine another external target associated with another gaze vector based on the calibration information.

5. The head-mounted device of claim 1, wherein one or more computing devices are further configured to:
indicate the external target to the user; or
determine the external target based on an action of the user.

6. The head-mounted device of claim 1, wherein:
the gaze vector comprises a first gaze vector corresponding to a first time and a second gaze vector corresponding to a second time;
the camera vector comprises a first camera vector corresponding to the first time and a second camera vector corresponding to the second time; and
the external target has a first position at the first time and a second position at the second time.

7. A method, comprising:
receiving one or more images of an external scene from a first camera of a head-mounted device;
generating world information based on the one or more images of the external scene from the first camera, wherein the world information comprises a position of an external target in the external scene;
determining, based on the world information, a camera vector which corresponds to a direction from the first camera to the external target;
receiving one or more other images of an eye from a second camera of the head-mounted device;
generating gaze information based on the one or more other images of the eye from the second camera, wherein the gaze information comprises a gaze direction of the eye, wherein the gaze direction is associated with the external target;
determining, based on the gaze information, a gaze vector which corresponds to the gaze direction; and
determining, using the gaze vector and the camera vector, calibration information for calibrating the first camera and the second camera to each other.

8. The method of claim 7, further comprising determining another external target associated with another gaze vector based on the calibration information.

9. The method of claim 7, further comprising:
indicating the external target to the user; or
determining the external target based on an action of the user.

10. The method of claim 9, wherein said associating the gaze direction with the external target comprises determining a gaze direction in temporal proximity to either of said indicating the external target to the user or said determining the external target based on the action of the user.

11. The method of claim 7, wherein:
the gaze vector comprises a first gaze vector corresponding to a first time and a second gaze vector corresponding to a second time;
the camera vector comprises a first camera vector corresponding to the first time and a second camera vector corresponding to the second time; and
the external target has a first position at the first time and a second position at the second time.

12. The method of claim 7, wherein the calibration information is represented as a calibration matrix, the method further comprising:
determining an additional gaze vector;
receiving additional one or more images from the first camera with a temporal proximity to the gaze vector;
locating an additional gaze target in the additional one or more images based on the additional gaze vector and the calibration matrix.

13. The method of claim 7, wherein said determining the calibration information comprises determining a depth of the external target relative to the head-mounted device.

14. The method of claim 7, wherein the external target is displayed on a companion device.

15. A non-transitory, computer-readable storage device storing program instructions that, when executed on or across one or more processors, cause the one or more processors to:
receive one or more images of an external scene from a first camera of a head-mounted device;
generate world information based on the one or more images of the external scene from the first camera, wherein the world information comprises a position of an external target in the external scene;
determine, based on the world information, a camera vector which corresponds to a direction from the first camera to the external target;
receive one or more other images of an eye from a second camera of the head-mounted device;
generate gaze information based on the one or more other images of the eye from the second camera, wherein the gaze information comprises a gaze direction of the eye, wherein the gaze direction is associated with the external target;
determine, based on the gaze information, a gaze vector which corresponds to the gaze direction; and
determine, using the gaze vector and the camera vector, calibration information for calibrating the first camera and the second camera to each other.

16. The computer-readable storage media of claim 15, wherein the program instructions, when executed on or across the one or more processors, further cause the one or more processors to determine another external target associated with another gaze vector based on the calibration information.

17. The computer-readable storage media of claim 15, wherein the program instructions, when executed on or across the one or more processors, further cause the one or more processors to:
indicate the external target to the user; or
determine the external target based on an action of the user.

18. The computer-readable storage media of claim 17, wherein the program instructions, wherein executed on or across the one or more processors, cause the one or more processors to perform said associating the gaze direction with the external target by determining a gaze direction in temporal proximity to either of said indicating the external target to the user or said determining the external target based on the action of the user.

19. The computer-readable storage media of claim 15, wherein:
the gaze vector comprises a first gaze vector corresponding to a first time and a second gaze vector corresponding to a second time;
the camera vector comprises a first camera vector corresponding to the first time and a second camera vector corresponding to the second time; and
the external target has a first position at the first time and a second position at the second time.

20. The computer-readable storage media of claim 15, wherein said determining the calibration information comprises determining a depth of the external target relative to the head-mounted device.
